(19) United States
(12) Patent Application Publication
(10) Pub. No.: US 2013/0052485 A1
(43) Pub. Date: Feb. 28, 2013

(54) RECORDING STACK WITH A DUAL CONTINUOUS LAYER

(71) Applicants: Zhong Wu, Fremont, CA (US); Li Tang, Fremont, CA (US); Shoutao Wang, San Jose, CA (US); Abebe Hailu, San Jose, CA (US)

(72) Inventors: Zhong Wu, Fremont, CA (US); Li Tang, Fremont, CA (US); Shoutao Wang, San Jose, CA (US); Abebe Hailu, San Jose, CA (US)

(73) Assignee: SEAGATE TECHNOLOGY LLC, Cupertino, CA (US)

(21) Appl. No.: 13/217,531

(22) Filed: Aug. 25, 2011

(51) Int. Cl. G11B 5/66; G11B 5/84

(52) U.S. Cl. 428/827; 428/833; 428/832; 428/831; 428/833.1; 427/131

(57) ABSTRACT

A perpendicular magnetic recording stack with a dual continuous layer and a method of manufacturing the same. The perpendicular magnetic recording stack includes a substrate, one or more magnetic granular recording layers, and a dual continuous layer having first and second continuous layers. The first continuous layer, disposed between the second continuous layer and the magnetic granular recording layers, has an intermediate lateral exchange coupling, which is higher than the lateral exchange coupling of the magnetic granular layers. The second continuous layer has a higher lateral exchange coupling than the first continuous layer.

### BACKGROUND

Information may be stored on a perpendicular magnetic recording stack. Such information may be written to and/or read from the perpendicular magnetic recording stack using a read/write head.

### SUMMARY

Implementations described and claimed herein provide perpendicular magnetic recording stacks with a dual continuous layer. In one implementation, the perpendicular magnetic recording stack includes a substrate, one or more magnetic granular recording layers, and a dual continuous layer having first and second continuous layers. The first continuous layer, disposed between the second continuous layer and the magnetic granular recording layers, has an intermediate lateral exchange coupling, which is higher than the lateral exchange coupling of the magnetic granular layers. The second continuous layer has a higher lateral exchange coupling than the first continuous layer.

These and various other features will be apparent from a reading of the following detailed description.

### BRIEF DESCRIPTIONS OF THE DRAWINGS

FIG. 1 illustrates an example perpendicular magnetic recording system.

FIG. 2 illustrates an example perpendicular magnetic recording stack having a dual continuous layer.

FIG. 3 illustrates example operations for manufacturing a perpendicular magnetic recording stack having a dual continuous layer.

### DETAILED DESCRIPTIONS

Perpendicular magnetic recording systems, such as systems including a perpendicular recording head and a perpendicular magnetic recording stack with a Coupled Granular/Continuous (CGC) structure having a dual continuous layer, can exhibit ultra high density recording capability resulting in an increased storage capacity.

The storage capacity of a perpendicular magnetic recording stack may be improved by increasing the areal density of a magnetic granular recording layer. However, as the areal density of a magnetic granular recording layer increases, other performance factors may become more relevant, including without limitation the thermal stability of the magnetic granular recording layer, recording ease (i.e., writability), and media noise.

Generally, a magnetic granular recording layer includes magnetic grains. The thermal stability of the magnetic granular recording layer is based on the magnetic anisotropy of the magnetic granular recording layer and the volume of the magnetic grain, which is proportional to the thickness of the magnetic granular recording layer. Decreasing the volume of the magnetic grains increase the areal recording density but also decreases the thermal stability of the magnetic granular recording layer. The magnetic grains become thermally unstable as their volumes approach their superparamagnetic limit, causing thermal fluctuations in the layer that compete with anisotropy energy of the magnetic grains. The superparamagnetic limit is reached when thermal fluctuations result in magnetization reversal against the magnetic anisotropy energy of the magnetic grains. Accordingly, thermal stability may be improved by increasing the average magnetic anisotropy energy of the magnetic grains in the magnetic granular recording layer.

However, increasing the average magnetic anisotropy energy of the magnetic grains may lead to problems with recording ease due to the high saturation fields of the magnetic granular recording layer and the limited saturation magnetization of the head material. For example, increasing the average magnetic anisotropy energy of the magnetic grains increases the switching field, which is the magnetic field needed to change the magnetic orientation of the magnetic grains during a write operation. As such, simply increasing the average magnetic anisotropy energy of the magnetic grains does not wholly resolve the problems with increased areal density.

A CGC structure optimizes intergranular exchange coupling to balance the Signal-to-noise ratio (SNR) with the thermal stability. A CGC structure may include a single continuous layer, which is a thin film exhibiting high perpendicular magnetic anisotropy and having exchange coupling that is continuously expanded laterally. The continuous layer has a strong lateral exchange coupling within the layer and is vertically exchange coupled with the magnetic granular recording layer. The vertical exchange coupling with the magnetic granular recording layer reduces the switching field, and the higher volume coupled between the continuous layer and the magnetic granular recording layer increases thermal stability. However, as a result, the switching volume during writing is increased, which may result in additional transition noise, increased jitter, and reduced capability to extend linear density of recording.

The SNR is proportional to the number of magnetic grains in a recording bit. The granular nature of a magnetic granular recording layer may result in noise due to irregularities of bit transitions. For example, the noise may result from vertical exchange coupling, distribution of the anisotropy field, and the write field gradient. The thermal stability and SNR may be improved by adjusting the material, structure, and thickness of the continuous layer. For example, the vertical exchange coupling between the continuous layer, with a given saturation magnetization, M_{S}, and magneto-crystalline anisotropy, and the magnetic granular layer may be changed by adjusting the thickness of the continuous layer. However, the thickness of the continuous layer, adjusted to achieve optimized vertical exchange coupling, additionally affects the mechanical robustness of the perpendicular magnetic recording stacks and may result in spacing loss. For example, the continuous layer may be thin, resulting in a lower overall lateral exchange coupling and a lower switching volume, which produces less noise during recording. However, a thin continuous layer often has poor mechanical robustness. Alternatively, the continuous layer may be thick, resulting in a larger overall lateral exchange coupling, which increases mechanical robustness. However, a thick continuous layer often experiences spacing loss during writing and reading. Accordingly, mechanical robustness and recording performance should be balanced.

Perpendicular magnetic recording stacks with a dual continuous layer improve the balance between mechanical robustness and magnetic properties, including recording performance. The dual continuous layer permits the vertical exchange coupling between the dual continuous layer and the magnetic granular recording layer to be tuned over a large range while the total thickness of the dual continuous layer is controlled over a relatively small range, resulting in maximized mechanical performance with minimum spacing loss during writing and reading.

TABLE 1

| | | | Mrt | | | | | | |
|---|---|---|---|---|---|---|---|---|---|
| Continuous Layer | H_{c} (Oe) | Hₙ (Oe) | $( \frac{memu}{{cm}^{2}} )$ | WPE (μinch) | Rev_OW (dB) | PE (dec) | OTC (dec) | ESMNR (dB) | ESNR (dB) |
| Single | 5062 | 2559 | 0.85 | 2.69 | −35.2 | −2.69 | −2.49 | 12.5 | 11.7 |
| Dual | 4864 | 2106 | 0.79 | 2.74 | −33.2 | −3.21 | −2.91 | 13.8 | 12.7 |

Table 1 compares magnetic properties and recording parametric for perpendicular magnetic recording stacks having a single continuous layer with perpendicular magnetic recording stacks having a dual continuous layer. The magnetic properties include: coercivity field, H_{c}, nucleation field, Hₙ, and magnetization thickness product, Mrt. The recording parametric include: writing plus erasure, WPE, reverse over-write, Rev_OW, on track bit error rate, PE, off track bit error rate, OTC, media signal noise ratio, ESMNR, and total signal noise ratio, ESNR. As shown in Table 1, the dual continuous layer improves the magnetic properties and recording parametric.

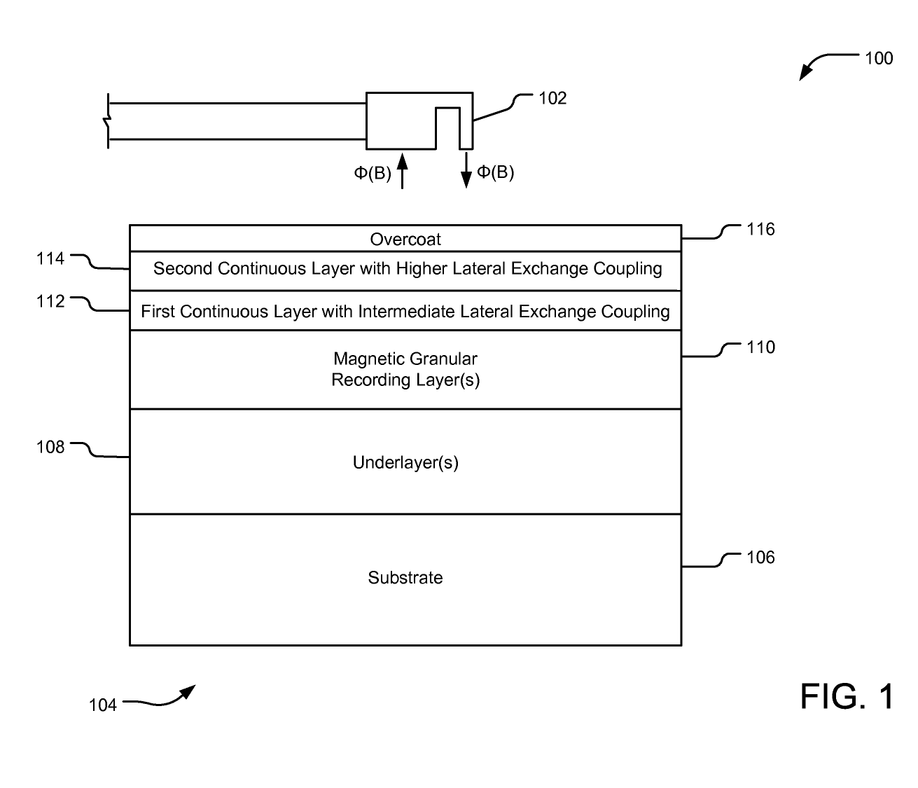

FIG. 1 illustrates an example perpendicular magnetic recording system 100. The perpendicular magnetic recording system 100 includes a read/write head 102, which generates a magnetic field perpendicular to a perpendicular magnetic recording stack 104.

In one implementation, the perpendicular magnetic recording stack 104 includes a substrate 106, one or more underlayers 108, one or more magnetic granular recording layers 110, and a dual continuous layer including a first continuous layer 112 and a second continuous layer 114.

The one or more underlayers 108 are disposed over the substrate 106, which is made from a non-magnetic material. In one implementation, the underlayer(s) 108 includes at least one soft magnetic underlayer (SUL).

The SUL guides magnetic flux emanating from the read/write head 102 through the magnetic granular recording layer(s) 110. The magnetic flux emanates from a writing pole of the read/write head 102 and passes through the magnetic granular recording layer(s) 110 into the SUL. Accordingly, a magnetic circuit is formed between the read/write head 102, the magnetic granular recording layer(s) 110, and the SUL.

The underlayer(s) 108 may include additional layers, such as one or more interlayers and/or an adhesion layer. In one implementation, the interlayer(s) are made from non-magnetic material. The interlayer(s) prevent interaction between the SUL and the magnetic granular recording layer(s) 110. Further, the interlayer(s) promote crystalline, microstructural and magnetic properties of the magnetic granular recording layer(s) 110. For example, residual magnetization is formed along an easy axis in a direction perpendicular to the surface of the magnetic granular recording layer(s) 110. The adhesion layer increases the adhesion between the substrate 106 and the SUL and provides low surface roughness.

Each of the one or more magnetic granular recording layers 110 are data storage layers. In one implementation, the magnetic granular recording layer(s) 110 is a hard magnetic material, which neither magnetizes nor demagnetizes easily. The magnetic granular recording layer(s) 110 has a granular structure, which includes magnetic crystal grains segregated by nonmagnetic substances, such as oxides, at the grain boundaries. The magnetic crystal grains exhibit perpendicular magnetic anisotropy. The magnetic granular recording layer(s) 110 may be, for example, a single thin film layer, multiple adjacent magnetic granular layers, or a laminated structure with a plurality of magnetic films separated by thin non-magnetic spacing layer(s).

The dual continuous layer includes the first continuous layer 112 and the second continuous layer 114. The first continuous layer 112 is disposed between the magnetic granular recording layer(s) 110 and the second continuous layer 114. However, the first continuous layer 112 is not necessarily adjacent to the magnetic granular recording layer(s) 110 and/or the second continuous layer 114, and there may be additional layers. The first continuous layer 112 has an intermediate lateral exchange coupling, which is higher than the lateral exchange coupling of the magnetic granular recording layer(s) 110. The second continuous layer 114 has a higher lateral exchange coupling than the first continuous layer 112. The dual continuous layer permits the vertical exchange coupling between the continuous layers 112 and 114 and the magnetic granular recording layer(s) 110 to be tuned within a large range while the total thickness of the dual continuous layer results in maximized mechanical performance with minimum spacing loss. Further, the higher lateral exchange coupling of the second continuous layer 114 provides a higher amplitude in reading and an increased vertical exchange coupling to the magnetic granular recording layer(s) 110, which improves media recording bit error rate and linear density.

In one implementation, the thickness of the first continuous layer 112 having the intermediate lateral exchange coupling is greater than the thickness of the second continuous layer 114 having the higher lateral exchange coupling. For example, the first continuous layer 112 may have a thickness of approximately 10-80 Å, and the second continuous layer 114 may have a thickness of approximately 2-20 Å. In another implementation, the thickness of the first continuous layer 112 is within the range 20-60 Å, and the thickness of the second continuous layer 114 is within the range 3-15 Å. Additionally, with respect to the second continuous layer 114, the coercivity field H_{c} decreases and the magnetization thickness product Mrt increases as the thickness of the second continuous layer 114 increases.

Further, in one implementation, the second continuous layer 114 has a saturation magnetization (M_{S}) larger than the saturation magnetization for the first continuous layer 112. For example, the first continuous layer 112 may have a saturation magnetization of approximately 10-800 emu/cm³, and the second continuous layer 114 may have a saturation magnetization of approximately 100-1200 emu/cm³. In another implementation, the first continuous layer 112 has a saturation magnetization within the range 100-600 emu/cm³, and the second continuous layer 114 has a saturation magnetization within the range 200-1000 emu/cm³. In still another implementation, the first continuous layer 112 has a saturation magnetization within the range 200-500 emu/cm³, and the second continuous layer 114 has a saturation magnetization within the range 400-900 emu/cm³.

In one implementation, the first continuous layer 112 and the second continuous layer 114 may have different material content. For example, the first continuous layer 112 may comprise a material having alloys including Co, with single or multiple elements, including but not limited to Cr, Pt, Ni, Ta, B, Nb, O, Ti, Si, Mo, Cu, Ag, Ge, and Fe. The second continuous layer 114 may comprise a material having alloys including Co, with single or multiple elements, including but not limited to Cr, Pt, Ni, Ta, B, Nb, O, Ti, Si, Mo, Cu, Ag, Ge, Fe. In one implementation, the first continuous layer 112 comprises a material having a an atomic concentration of Co that is lower than 70 atomic percent, and the second continuous layer 114 comprises a material having an atomic concentration of Co that is higher than 70 atomic percent. However, other concentrations and materials are contemplated.

The magnetic recording stack 104 may further include an overcoat 116. The overcoat 116 protects the second continuous layer 114 from the impact of the read/write head 102 and improves the lubricity between the read/write head 102 and the magnetic recording stack 104. The overcoat 116 may include, for example, a carbon based film having a diamond-like structure.

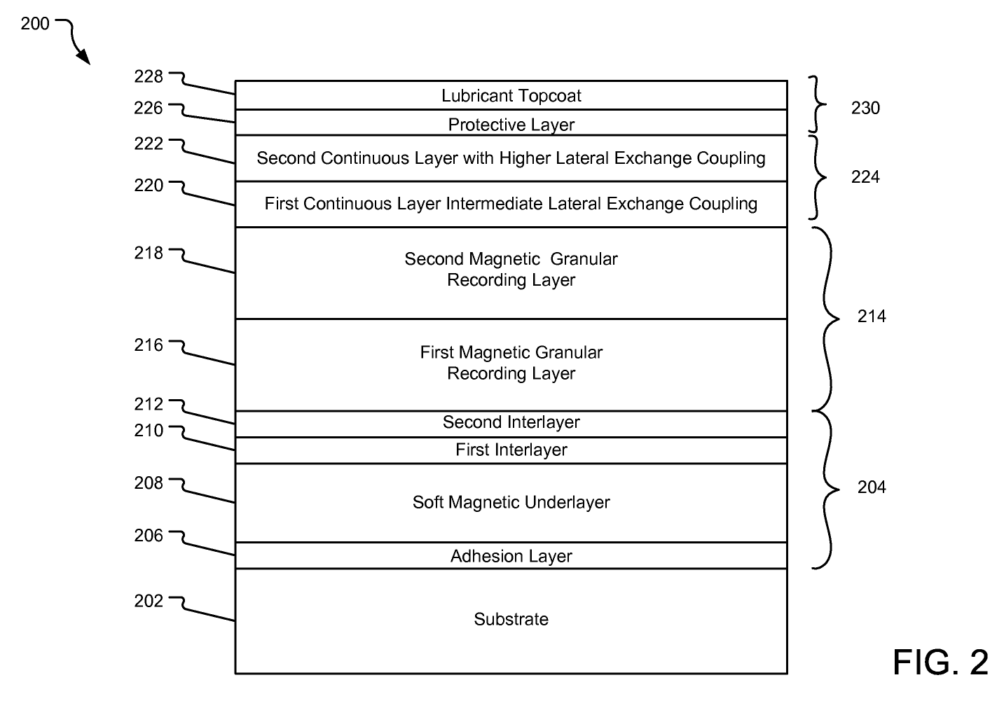

FIG. 2 illustrates an example perpendicular magnetic recording stack 200 having a dual continuous layer. In one implementation, the perpendicular recording stack 200 includes a substrate 202, an underlayer 204, a magnetic granular recording layer 214, a dual continuous layer 224, and an overcoat 230. However, the perpendicular magnetic recording stack 200 may have more or less layers.

In one implementation, the substrate 202 is made from a non-magnetic material, such as non-magnetic metal or alloy (e.g., Al, an Al-based alloy, and AlMg having a NiP plating layer on a deposition surface to increases hardness), glass, ceramic, glass-ceramic, polymeric material, or a composite or laminate of similar materials. The substrate 202 may be disk-shaped. However, other shapes are contemplated.

The underlayer 204 is disposed over the substrate 202. In one implementation, the underlayer 204 includes an adhesion layer 206, a SUL 208, a first interlayer 210, and a second interlayer 212. However, the underlayer 204 may have more or less layers.

The adhesion layer 206 increases the adhesion between the substrate 202 and the SUL 208 and provides low surface roughness. In one implementation, the adhesion layer 206 is amorphous. Further, the adhesion layer 206 may control the anisotropy of the SUL 208. The adhesion layer 206 may be up to approximately 200 Å thick and be made, for example, from a materials including but not limited to Ti, a Ti-based alloy, Cr, and a Cr-based alloy.

The SUL 208 guides magnetic flux emanating from a head during writing through the magnetic granular recording layer 214. The SUL 208 is made from a material exhibiting soft magnetic characteristics, such as a material that may be easily magnetized and demagnetized. For example, the SUL 208 may be made from a soft magnetic material including but not limited to Ni, NiFe (Permalloy), Co, Fe, an Fe-containing alloy (e.g., NiFe (Permalloy), FeN, FeSiAl, or FeSiAlN), a Co-containing alloy (e.g., CoZr, CoZrCr, CoZrNb), or a Co—Fe containing alloy (e.g., CoFeZrNb, CoFe, FeCoB, and or FeCoC). The thickness of the SUL 208 may be, for example, approximately 0-1200 Å. In one implementation, the SUL 208 has a sufficient saturation magnetization flux density (Bs) (e.g., 100-1,920 emu/cc) and a low anisotropy (Hₖ) (e.g., up to approximately 200 Oe). In one implementation, the SUL 208 material is amorphous, which exhibits no predominant sharp peak in an x-ray diffraction pattern as compared to background noise. In another implementation, the SUL 208 includes two SUL layers separated by a coupling layer, such that the two SUL layers have ferromagnetic or antiferromagnetic coupling across the coupling layer. The coupling layer may be comprised of a material including, without limitation, Ru, an Ru alloy, Cr, or a Cr alloy and may be approximately 0 to 30 Å thick.

In one implementation, the underlayer 204 includes first interlayer 210 and second interlayer 212, which are made from non-magnetic material (e.g., a Ru alloy). The interlayers 210 and 212 prevent interaction between the SUL 208 and the magnetic granular recording layer 214. Further, the interlayers 210 and 212 promote microstructural and magnetic properties of the magnetic granular layers 214. For example, the interlayers 210 and 212 establish a hexagonal close-packed (HCP) crystalline orientation that induces <002> growth orientation in the magnetic granular recording layer 214, with a magnetic easy axis perpendicular to the plane of the magnetic granular recording layer 214.

In one implementation, the magnetic granular recording layer 214 includes a first magnetic granular recording layer 216 and a second magnetic recording layer 218, which are adjacent and may have different magnetic and/or intrinsic properties. However, in other implementations, the magnetic granular recording layer 214 may be a single thin film layer or a laminated structure with a plurality of magnetic films separated by thin non-magnetic spacing layer(s). The total film thickness of the magnetic granular recording layer 214 may be, for example, approximately 20-200 Å.

The magnetic granular recording layer 214 is a data storage layer. In one implementation, the magnetic granular recording layer 214 is a hard magnetic material, which neither magnetizes nor demagnetizes easily. The magnetic granular recording layer 214 has a granular structure, which includes magnetic crystal grains segregated by nonmagnetic substances at the grain boundaries. In one implementation, the magnetic crystal grains are made from magnetic alloys, such as Co alloys, with single or multiple elements, including but not limited to Cr, Ni, Pt, Ta, B, Nb, O, Ti, Si, Mo, Cu, Ag, Ge, and Fe. The nonmagnetic substances may be oxides including but not limited to SiO₂, TiO2,CoO, Cr₂O₃, and Ta₂O₅, WO₃, Nb₂O₅, B₂O₃, or a mixture of these oxides. The magnetic crystal grains exhibit perpendicular magnetic anisotropy. The crystalline anisotropy in this film may be, for example, approximately 0-25 k Oe.

The magnetic granular recording layer 214 is vertically exchange coupled with the dual continuous layer 224. In one implementation, the dual continuous layer 224 is a thin film including a first continuous layer 220 and a second continuous layer 222. The first continuous layer 220 is disposed between the magnetic granular recording layer 214 and the second continuous layer 222. However, the first continuous layer 220 is not necessarily adjacent to the magnetic granular recording layer 214 and/or the second continuous layer 222, and there may be additional layers. The continuous layers 220 and 222 exhibit high perpendicular magnetic anisotropy and have exchange coupling that is continuously expanded laterally. Each of the continuous layers 220 and 222 have a strong lateral exchange coupling within the layer. The first continuous layer 220 has an intermediate lateral exchange coupling, which is higher than the lateral exchange coupling of the magnetic granular recording layer 214. The second continuous layer 222 has a higher lateral exchange coupling than the first continuous layer 220. The dual continuous layer 224 permits the vertical exchange coupling between the continuous layers 220 and 222 and the magnetic granular recording layer 214 to be tuned within a large range while the total thickness of the dual continuous layer 224 results in maximized mechanical performance with minimum spacing loss. Further, the higher lateral exchange coupling of the second continuous layer 222 provides higher amplitude in reading and an increased vertical exchange coupling to the magnetic granular recording layers 214, which improves media recording bit error rate and linear density.

In one implementation, the thickness of the first continuous layer 220 having the intermediate lateral exchange coupling is greater than the thickness of the second continuous layer 222 having the higher lateral exchange coupling. For example, the first continuous layer 220 may have a thickness of approximately 10-80 Å, and the second continuous layer 222 may have a thickness of approximately 2-20 Å. In another implementation, the thickness of the first continuous layer 220 is within the range 20-60 Å, and the thickness of the second continuous layer 222 is within the range 3-15 Å. Additionally, with respect to the second continuous layer 222, the coercivity field H_{C} decreases and the magnetization thickness product Mrt increases as the thickness of the second continuous layer 222 increases.

Further, in one implementation, the second continuous layer 222 has a saturation magnetization (M_{S}) larger than the saturation magnetization for the first continuous layer 220. For example, the first continuous layer 220 may have a saturation magnetization of approximately 10-800 emu/cm³, and the second continuous layer 222 may have a saturation magnetization of approximately 100-1200 emu/cm³. In another implementation, the first continuous layer 220 has a saturation magnetization within the range 100-600 emu/cm³, and the second continuous layer 222 has a saturation magnetization within the range 200-1000 emu/cm³. In still another implementation, the first continuous layer 220 has a saturation magnetization within the range 200-500 emu/cm³, and the second continuous layer 222 has a saturation magnetization within the range 400-900 emu/cm³.

In one implementation, the first continuous layer 220 and the second continuous layer 222 may have different material content. For example, the first continuous layer 220 may comprise a material having alloys including Co, with single or multiple elements, including but not limited to Cr, Pt, Ni, Ta, B, Nb, O, Ti, Si, Mo, Cu, Ag, Ge, and Fe. The second continuous layer 222 may comprise a material having alloys including Co, with single or multiple elements, including but not limited to Cr, Pt, Ni, Ta, B, Nb, O, Ti, Si, Mo, Cu, Ag, Ge, Fe. In one implementation, the first continuous layer 112 comprises a material having a an atomic concentration of Co that is lower than 70 atomic percent, and the second continuous layer 114 comprises a material having an atomic concentration of Co that is higher than 70 atomic percent. However, other concentrations and materials are contemplated.

In one implementation, the overcoat 230 includes a protective layer 226 and a lubricant layer 228. The protective layer 226 protects the perpendicular magnetic recording stack 200 from the impact of a head during writing and reading. In one implementation, the protective layer 226 has a diamond-like structure and is made from an amorphous carbon material further including, for example, hydrogen, nitrogen, hybrid ion-beam deposition, ion-beam deposition utilizing a chemical gas, or a mixture. The lubricant layer 228 improves the lubricity between a head and the perpendicular magnetic recording stack 200. The lubricant layer 228 may be, for example, a perfluoropolyether (PFPE) film.

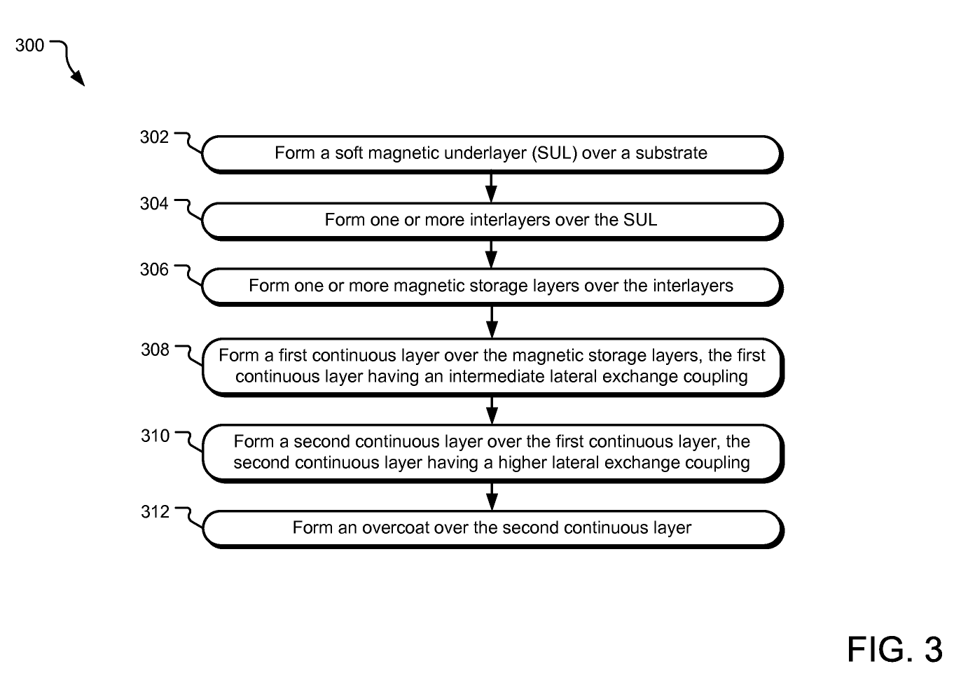

FIG. 3 illustrates example operations 300 for manufacturing a perpendicular magnetic recording stack having a dual continuous layer.

A SUL forming operation 302 forms a SUL over a substrate. In one implementation, the substrate is made from a non-magnetic material, such as non-magnetic metal or alloy (e.g., Al, an Al-based alloy, and AlMg having a NiP plating layer on a deposition surface to increases hardness), glass, ceramic, glass-ceramic, polymeric material, or a composite or laminate of similar materials.

The SUL forming operation 302 deposits the SUL on the substrate. In one implementation, the SUL is amorphous and may be made from an soft magnetic material including but not limited to Ni, NiFe (Permalloy), Co, Fe, an Fe-containing alloy (e.g., NiFe (Permalloy), FeN, FeSiAl, or FeSiAlN), a Co-containing alloy (e.g., CoZr, CoZrCr, CoZrNb), or a Co-Fe containing alloy (e.g., CoFeZrNb, CoFe, FeCoB, and or FeCoC). The SUL forming operation 302 deposits the SUL such that the thickness is, for example, approximately 0-1200 Å.

In one implementation, the SUL forming operation 302 includes depositing an amorphous adhesion layer onto the substrate prior to depositing the SUL. The SUL forming operation 302 deposits the adhesion layer, for example, such that the thickness is up to approximately 200 Å thick and the material content includes Ti, a Ti-based alloy, Cr, or a Cr-based alloy. The SUL forming operation 302 may further include depositing additional nonmagnetic lamination layers.

An interlayer forming operation 304 deposits one or more interlayers on the SUL. In one implementation, the one or more interlayers are made from non-magnetic material (e.g., a Ru alloy) with a <002> growth orientation.

A magnetic layer forming operation 306 forms one or more magnetic storage layers over the one or more interlayers. In one implementation, the magnetic layer forming operation 306 deposits one or more magnetic storage layers on the interlayers such that the one or more magnetic storage layers grow with an HCP <002> growth orientation. The one or more magnetic storage layers may be multiple adjacent layers, a single thin film layer, or a laminated structure with a plurality of magnetic films separated by thin non-magnetic spacing layer(s). In one implementation, the magnetic layer forming operation 306 deposits the one or more magnetic storage layers such that the total film thickness is, for example, approximately 20-200 Å. Further, the magnetic layer forming operation 306 deposits the one or more magnetic storage layers to form a compositionally segregated microstructure, which includes magnetic crystal grains segregated by nonmagnetic substances at the grain boundaries. In one implementation, the magnetic crystal grains are made from magnetic alloys, such as Co alloys, with single or multiple elements, including but not limited to Cr, Ni, Pt, Ta, B, Nb, O, Ti, Si, Mo, Cu, Ag, Ge, and Fe. The nonmagnetic substances may be oxides including but not limited to SiO₂, TiO2,CoO, Cr₂O_{3, and Ta}₂O₅,WO₃, Nb₂O₅, B₂O₃, or a mixture of these oxides. The magnetic crystal grains exhibit perpendicular magnetic anisotropy. The crystalline anisotropy in this film may be, for example, approximately 0-25 k Oe.

A first continuous layer forming operation 308 forms a first continuous layer, proximal to the substrate, over the one or more magnetic storage layers. The first continuous layer forming operation 308 deposits the first continuous layer such that there is an intermediate lateral exchange coupling, which is higher than the lateral exchange coupling of the one or more magnetic storage layers. In one implementation, the first continuous layer forming operation 308 deposits the first continuous layer with a thickness of approximately 10-80 Å. In another implementation, the first continuous layer is deposited with a thickness of approximately 20-60 Å. Further, the first continuous layer forming operation 308 deposits the first continuous layer in one implementation such that the first continuous layer has a saturation magnetization of approximately 10-800 emu/cm³. In another implementation, the first continuous layer is deposited to have a saturation magnetization of 100-600 emu/cm³. In still another implementation, the first continuous layer is deposited to have a saturation magnetization within the range 200-500 emu/cm³. The first continuous layer forming operation 308 deposits the first continuous layer to form a material having, for example, alloys including Co, with single or multiple elements, including but not limited to Cr, Pt, Ni, Ta, B, Nb, O, Ti, Si, Mo, Cu, Ag, Ge, and Fe. In one implementation, the first continuous layer forming operation 308 deposits the first continuous layer to form a material having a an atomic concentration of Co that is lower than 70 atomic percent. However, other concentrations and materials are contemplated.

A second continuous layer forming operation 310 forms a second continuous layer, distal to the substrate, over the first continuous layer. The second continuous layer forming operation 310 deposits the second continuous layer such that there is a higher lateral exchange coupling than the first continuous layer. In one implementation, the second continuous layer forming operation 310 deposits the second continuous layer with a thickness that is less than the thickness of the first continuous layer. For example, in one implementation, the second continuous layer forming operation 310 deposits the second continuous layer with a thickness of approximately 2-20 Å. In another implementation, the second continuous layer is deposited with a thickness of approximately 3-15 Å. Further, in one implementation, the second continuous layer forming operation 310 deposits the second continuous layer such that the second continuous layer has a saturation magnetization (M_{S}) larger than the saturation magnetization for the first continuous layer. For example, in one implementation, the second continuous layer is deposited to have a saturation magnetization of approximately 100-1200 emu/cm³. In another implementation, the second continuous layer is deposited to have a saturation magnetization of approximately 200-1000 emu/cm³. In still another implementation, the second continuous layer is deposited to have a saturation magnetization of approximately 400-900 emu/cm³. The second continuous layer forming operation 310 deposits the second continuous layer to form a material having, for example, alloys including Co, with single or multiple elements, including but not limited to Cr, Pt, Ni, Ta, B, Nb, O, Ti, Si, Mo, Cu, Ag, Ge, Fe. In one implementation, the second continuous layer forming operation 310 deposits the second continuous layer to form a material having an atomic concentration of Co that is higher than 70 atomic percent. However, other concentrations and materials are contemplated.

An overcoat forming operation 312 forms and overcoat over the second continuous layer. In one implementation, the overcoat forming operation 312 deposits an amorphous carbon alloy structure and a polymer lubricant onto the second continuous layer.

The operations 300 may include additional and/or fewer operations and may be performed in any order.

The above specification, examples, and data provide a complete description of the structure and use of example implementations of the invention. Many implementations of the invention can be made without departing from the spirit and scope of the invention. Furthermore, structural features of the different implementations may be combined in yet another implementation without departing from the recited claims. The implementations described above and other implementations are within the scope of the following claims.

What is claimed is:

1. A magnetic recording stack comprising:
a substrate;
one or more magnetic granular recording layers disposed over the substrate, each of the one or more magnetic granular recording layers having a lateral exchange coupling;
a first continuous layer having an intermediate lateral exchange coupling higher than the lateral exchange coupling of the one or more magnetic granular recording layers; and
a second continuous layer having a higher lateral exchange coupling than the lateral exchange coupling of the first continuous layer, wherein the first continuous layer is disposed between the one or more magnetic granular recording layers and the second continuous layer.

2. The magnetic recording stack of claim 1, further comprising:
one or more underlayers disposed between the substrate and the one or more magnetic granular recording layers.

3. The magnetic recording stack of claim 1, further comprising:
an overcoat disposed over the second continuous layer.

4. The magnetic recording stack of claim 1, wherein the one or more underlayers includes a soft magnetic underlayer, an adhesion layer, and one or more interlayers.

5. The magnetic recording stack of claim 1, wherein a thickness of the first continuous layer is greater than a thickness of the second continuous layer.

6. The magnetic recording stack of claim 1, wherein a saturation magnetization of the second continuous layer is larger than the saturation magnetization of the first continuous layer.

7. The magnetic recording stack of claim 1, wherein a material content of the first continuous layer and the second continuous layer comprises a Co alloy with one or more elements selected from: Cr, Pt, Ni, Ta, B, Nb, O, Ti, Mo, Cu, Ag, Ge, and Fe.

8. A magnetic recording stack comprising:
a substrate;
one or more magnetic granular recording layers disposed over the substrate, each of the one or more magnetic granular recording layers having a lateral exchange coupling;
a first continuous layer having an intermediate lateral exchange coupling higher than the lateral exchange coupling of the one or more magnetic granular recording layers; and
a second continuous layer having a higher lateral exchange coupling than the lateral exchange coupling of the first continuous layer, wherein a thickness of the first continuous layer is greater than a thickness of the second continuous layer and a saturation magnetization of the second continuous layer is higher than a saturation magnetization of the first continuous layer.

9. The magnetic recording stack of claim 8, wherein the thickness of the first continuous layer ranges between 10-80 Å and the thickness of the second continuous layer ranges between 2-20 Å.

10. The magnetic recording stack of claim 8, wherein the thickness of the first continuous layer ranges between 20-60 Å and the thickness of the second continuous layer ranges between 3-15 Å.

11. The magnetic recording stack of claim 8, wherein the saturation magnetization of the first continuous layer ranges between 10-800 emu/cm³ and the saturation magnetization of the second continuous layer ranges between 100-1200 emu/cm³.

12. The magnetic recording stack of claim 8, wherein the saturation magnetization of the first continuous layer ranges between 100-600 emu/cm³ and the saturation magnetization of the second continuous layer ranges between 200-1000 emu/cm³.

13. The magnetic recording stack of claim 8, wherein the saturation magnetization of the first continuous layer ranges between 200-500 emu/cm³ and the saturation magnetization of the second continuous layer ranges between 400-900 emu/cm³.

14. The magnetic recording stack of claim 8, wherein a material content of the first continuous layer and the second continuous layer comprises a Co alloy with one or more elements selected from: Cr, Pt, Ni, Ta, B, Nb, O, Ti, Mo, Cu, Ag, Ge, and Fe.

15. A method comprising:
depositing one or more underlayers on a substrate;
depositing one or more magnetic granular recording layers on the one or more underlayers, the one or more magnetic granular recording layers each having a lateral exchange coupling;
depositing a first continuous layer on the one or more magnetic granular recording layers, the first continuous layer having an intermediate lateral exchange coupling higher than the lateral exchange coupling of the one or more magnetic granular recording layers; and
depositing a second continuous layer on the first continuous layer, the second continuous layer having a higher lateral exchange coupling than the lateral exchange coupling of the first continuous layer.

16. The method of claim 15, further comprising:
depositing an overcoat on the second continuous layer.

17. The method of claim 15, wherein a thickness of the first continuous layer is greater than a thickness of the second continuous layer.

18. The method of claim 15, wherein a saturation magnetization of the second continuous layer is higher than a saturation magnetization of the first continuous layer.

19. The method of claim 15, wherein a material content of the first continuous layer and the second continuous layer comprises a Co alloy with one or more elements selected from: Cr, Pt, Ni, Ta, B, Nb, O, Ti, Mo, Cu, Ag, Ge, and Fe.

20. The method of claim 15, wherein the thickness of the first continuous layer ranges between 10-80 Å and the thickness of the second continuous layer ranges between 2-20 Å and wherein the saturation magnetization of the first continuous layer ranges between 10-800 emu/cm³ and the saturation magnetization of the second continuous layer ranges between 100-1200 emu/cm³.
